(19) United States
(12) Patent Application Publication
(10) Pub. No.: US 2005/0205426 A1
(43) Pub. Date: Sep. 22, 2005

(54) Additive injection system for in-situ soil remediation by electrokinetics and method for injecting additive using the system

(75) Inventors: Soo Sam Kim, Anyang-si (KR); Sang Jae Han, Euiwang-si (KR); Byung II Kim, Ansan-si (KR)

Correspondence Address: HOFFMANN & BARON, LLP, 6900 JERICHO TURNPIKE, SYOSSET, NY, 11791, US

(73) Assignee: Han Yang University

(21) Appl. No.: 10/802,183

(22) Filed: Mar. 17, 2004

(51) Int. Cl. C02F 1/469

(52) U.S. Cl. 204/515; 204/648

(57) ABSTRACT

Disclosed herein is an additive injection system for in-situ soil remediation by electrokinetics. Further disclosed is a method for injecting an additive using the system by inducing electroosmosis between negatively charged filler particles surrounding an electrode to allow water and flushing solution to flow into the soil, wherein the filler particles have a permeability lower than the soil.

### BACKGROUND OF THE INVENTION

1. Field of the Invention

The present invention relates to an additive injection system for in-situ soil remediation by electrokinetics, and more particularly to an additive injection system for in-situ soil remediation by electrokinetics which can prevent soil in the vicinity of an anode from being dried and reduce the risk of secondary contamination in the deep layer of soil upon electrokinetically decontaminating saturated or unsaturated soil.

2. Description of the Related Art

In general, heavy metal-contaminated soil around mining regions, oil-contaminated soil around gas stations and fertilizer-contaminated soil around rice fields are in need of remediation due to the need for environmental protection.

To remediate contaminated soil, remediation techniques using electrokinetics have been suggested. For the electrokinetic remediation of soil, first an anode and a cathode spaced apart from the anode by a fixed distance are installed in contaminated soil, and an additive (flushing solution) is added to the soil. Thereafter, when an electric current is applied to both electrodes, contaminants present in the soil are collected in the cathode due to electroosmosis and electromigration and extracted from the cathode.

Common remediation equipment using electrokinetics includes a plurality of anodes (a anodic compartment) and a plurality of cathodes (an cathodic compartment) spaced apart from the anodes by a fixed distance, the compartments being installed in contaminated soil to a predetermined depth, a power supply for supplying electric power to the anodic and cathodic compartments, a water supplier for supplying water to the anodic compartment, an extractor for extracting water and contaminants collected in the cathodic compartment, and a storage tank for storing the extracted water and contaminants.

When an electric current is applied to both the anodic compartment and cathodic compartment spaced apart from the anodic compartment by a fixed distance and installed in contaminated soil, contaminants such as heavy metals present in the soil are collected in the cathode due to electroosmosis and electromigration.

Thereafter, water and flushing solution suitable for removal of the contaminants are introduced to the contaminated soil. The addition causes the migration of the contaminants toward the cathodic compartment, thereby greatly improving the removal efficiency of contaminants. The contaminants collected in the cathodic compartment are extracted by the extractor and then removed.

However, when the contaminants are collected in the cathodic compartment by applying electric power and injecting water and flushing solution to the anodic compartment, non-uniform structures (pores) of the soil generate drift current of flushing solution, which reduces the removal efficiency of contaminants or causes flushing solution to flow into uncontaminated region of soil.

In addition, there is a problem in that since the contaminants migrate from the anodic compartment to the cathodic compartment together with water, soil in the vicinity of an anode is likely to be dried.

### SUMMARY OF THE INVENTION

Therefore, the present invention has been made in view of the above problems, and it is an object of the present invention to provide an additive injection system for in-situ soil remediation by electrokinetics which can prevent excess flushing solution from flowing into the soil, upon removing contaminants from soil by injecting flushing solution and water, thereby reducing the risk of secondary contamination in the deep layer and uncontaminated region of soil.

It is another object of the present invention to provide a method for injecting an additive using the system.

In order to accomplish the above objects of the present invention, there is provided an additive injection system, used in in-situ soil remediation by electrokinetics for removing heavy metals and organic substances present in a contaminated soil by applying electric power to an anode and a cathode to induce electroosmosis and electromigration in the soil wherein the anode and the cathode are oppositely installed in the soil and the cathode is spaced apart from the anode by a fixed distance, comprising:
a cylindrical housing; an electrode selected from the anode and the cathode and positioned in the cylindrical housing; a plurality of discharging slots formed in the cylindrical housing; a filter adhered to the inner surface of the housing; a negatively charged filler such as clayey soils filled in the housing and surrounding the electrode; and flushing solution supplied to the filler through an injection nozzle in such a manner that flushing solution is maintained at a constant level and flows into the soil by electroosmosis,

Wherein the filter has permeability higher than the filler and the filler has permeability lower than the soil.

In accordance with another aspect of the present invention, there is provided a method for injecting flushing solution into soil by inducing electroosmosis between negatively charged filler particles surrounding an electrode to allow water and flushing solution to flow into the soil,
wherein the filler particles have permeability lower than the contaminated soil.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a cross-sectional view showing an additive injection system for in-situ soil remediation by electrokinetics according to the present invention;

FIG. 2 is a cross-sectional view showing the state where an additive injection system of the present invention is used in a horizontal remediation technique;

FIG. 3 is a side cross-sectional view of the additive injection system for a horizontal or vertical remediation system;

FIG. 4 is a graph showing the distribution of the water content within the soil sample in accordance with one example of the present invention; and

FIG. 5 is a graph showing change in the concentration of heavy metals upon removing contaminants present in soil using an additive injection system of the present invention.

### DESCRIPTION OF THE PREFERRED EMBODIMENTS

Hereinafter, the present invention will be explained in more detail with reference to the accompanying drawings.

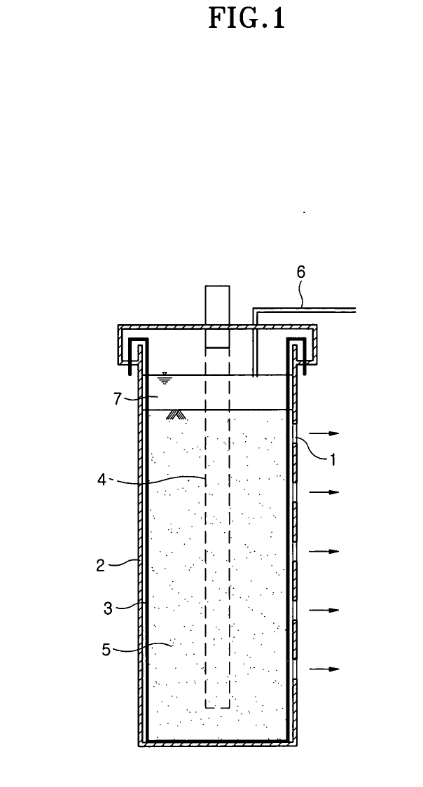

FIG. 1 is a cross-sectional view showing an additive injection system for in-situ soil remediation by electrokinetics according to the present invention. As shown in FIG. 1, the additive injection system of the present invention comprises a cylindrical housing 2 made of a PVC or steel tube, a plurality of discharging slots 1 formed in the cylindrical housing 2, a filter 3 adhered to the inner surface of the housing 2, an electrode 4 inserted into the central part of the housing 2, a negatively charged filler 5 such as kaolinite filled in the housing 2 and surrounding the electrode 4, and flushing solution 7 such as a surfactants or complexing agents supplied to the filler 5 through an injection nozzle 6 in such a manner that flushing solution 7 is maintained at a constant level wherein the filter 3 has a permeability higher than the filler 5, and the filer 5 has a permeability lower than the soil.

Since the filler 5 particles are in direct contact with the electrode 4 to generate electroosmosis and the filler 5 has a permeability lower than soil (to be decontaminated), the additive injection system of the present invention can prevent an excess of flushing solution 7 from flowing into the soil.

Preferably, the number and diameter of the discharging slots 1 formed on the housing 2 are maximized such that flushing solution 7 and water flow easily out from the housing 2 with minimized resistance.

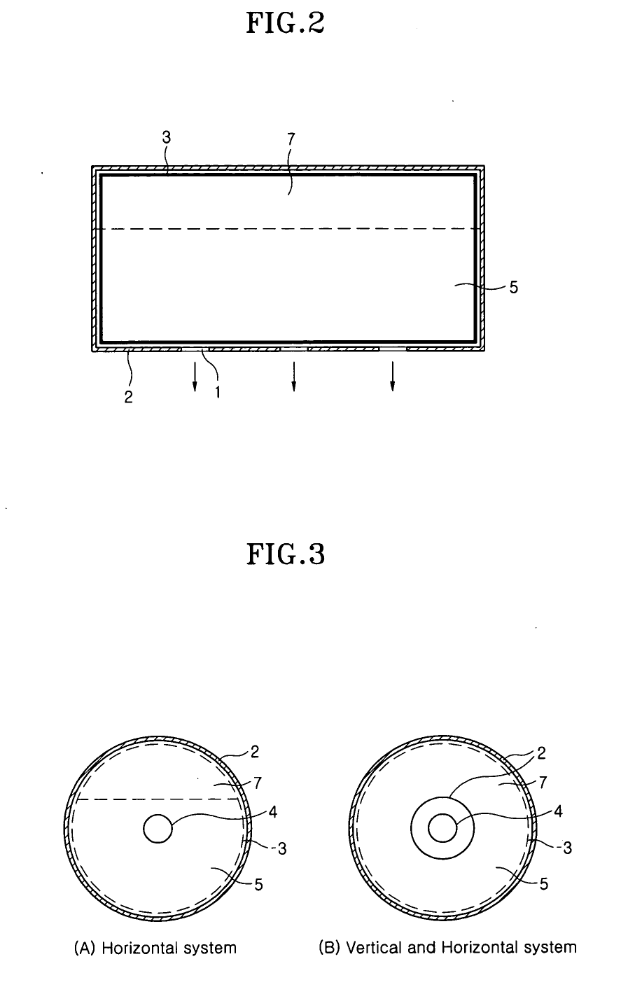

When the housing 2 is manufactured in order to apply in a horizontal electrode system as shown in FIGS. 2 and 3, instead of a vertical application, flushing solution 7 occupies ⅓ portion from the top face of the housing 2 after adhering the filter 3 to the inner surface of the housing 2 and the filler 5 fills up the remaining portion of the housing 2 and surrounds the electrode 4.

A method for decontaminating soil using a remediation equipment in which the additive injection system is installed is explained below.

First, an anode (surrounded by a housing 2 and a filler 5) and a cathode were inserted into a soil sample by a fixed distance. 50 mM citric acid solution as flushing solution 7 was injected into the housing 2 through an injection nozzle 6.

After the citric acid solution filled up the housing 2 to completely cover the filler 5, a voltage of 50V was applied to the anode and the cathode. At the same time, an extraction system connected to the cathodic compartment was operated with a negative pressure of 0.5 kg/cm². Contaminants (heavy metals and organic substances) were collected in the cathode and extracted by the action of the extraction system.

At this time, the saturation degree of the soil sample was set to the optimum water content under the maximum wet unit weight. The characteristics of the used soil are shown in Table 1 below.

TABLE 1

| Spe- | | | | CEC | | | |
|---|---|---|---|---|---|---|---|
| cific | Liq- | USCS | In- | (meq/100 g | Organic | Carbon | Specific |
| grav- | uid | classi- | itial | dried | content | content | area |
| ity | limit | fication | pH | soil | (%) | (%) | (m²/g) |
| 2.56 | 25.4 | SW | 6.6 | 3.91 | 3.36 | 0.18 | 10.5 |

After the anode and cathode were installed in the soil sample, experiments were performed. Heavy metals present in the soil sample were removed as shown in FIG. 5. As shown in FIG. 5, the degree of initial contamination was measured to be 37 mg/Kg. 10, 20 and 30 days after the measurement, the concentration of heavy metals was measured at the normalized distance from the anode.

35 days after the measurement, the concentration of heavy metals was drastically reduced to about 20 mg/kg, irrespective of the distance from the anode.

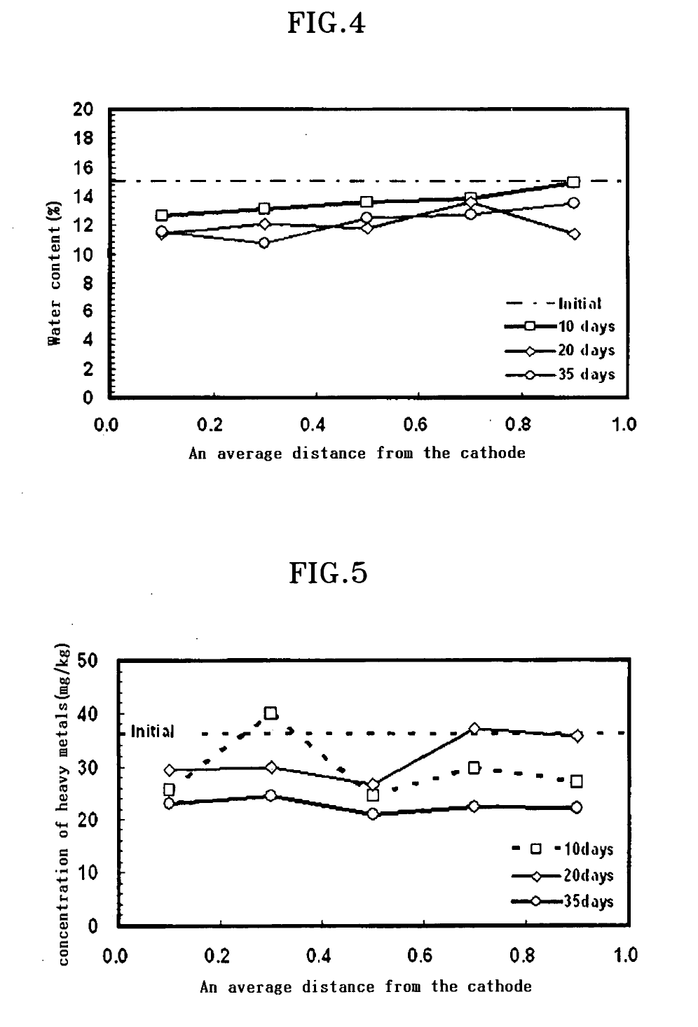

FIG. 4 is a graph showing the distribution of the water content (%) in the soil. As shown in FIG. 4, the initial water content was set to 15%. 10 days after the measurement, the soil in the vicinity of the anode was not dried at all. 35 days after the measurement, the water content in the soil was maintained at about 14%. These results indicate that the injection of flushing solution 7 by electroosmosis plays an important role in the prevention of soil drying in the vicinity of the anode.

As apparent from the above description, the additive injection system for in-situ soil remediation by electrokinetics according to the present invention can prevent an excess of flushing solution from flowing into soil by electroosmosis, which is induced by the negatively charged filler filled in the housing, upon removing contaminants from soil by injecting flushing solution, thereby reducing the risk of secondary contamination in uncontaminated region of soil.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An additive injection system, used in in-situ soil remediation by electrokinetics for removing heavy metals and organic substances present in contaminated soil by applying electric power to an anode and a cathode to induce electroosmosis and electromigration in the soil wherein the anode and the cathode are oppositely installed in the soil and the cathode is spaced apart from the anode by a fixed distance, comprising:
a cylindrical housing; an electrode selected from the anode and the cathode and positioned in the cylindrical housing; a plurality of discharging slots formed in the cylindrical housing; a filter adhered to the inner surface of the housing; a negatively charged filler filled in the housing and surrounding the electrode; and flushing solution supplied to the filler through an injection nozzle in such a manner that flushing solution is maintained at a constant level and flows into the soil by electroosmosis,
wherein the filter has permeability higher than the filler and the filler has permeability lower than the soil.

2. A method for injecting flushing solution into soil comprising inducing electroosmosis between negatively charged filler particles surrounding an electrode to allow water and flushing solution to flow into said soil,
wherein the filler particles have permeability lower than the soil.
